(19) United States
(12) Patent Application Publication
(10) Pub. No.: US 2011/0088520 A1
(43) Pub. Date: Apr. 21, 2011

(54) TOOL

(76) Inventor: Manuel S. ALBRECHT, Muehlacker (DE)

(21) Appl. No.: 12/580,960

(22) Filed: Oct. 16, 2009

(51) Int. Cl. B25B 13/02; B25B 23/16

(52) U.S. Cl. 81/124.7; 81/177.7

(57) ABSTRACT

The tool according to the invention serves to rotate a work piece or a device around a rotational axis and has a handle and a shaped component, which can be brought into a form-fitting position with the work piece or the device. Herein the handle is able to swivel around a pivot axis arranged on the section of the handle toward the axis end side, whereby the moment of inertia and/or the momentum of the swiveled handle is transmittable as rotational momentum onto the shaped component and thus onto the work piece or the device, through a limitation on the swivelable extent. Thus an increased torque (for example, an initial breakaway or tightening torque) may be briefly applied onto the work piece or the device.

### TECHNICAL FIELD

The presently described invention relates to hand tools.

### BACKGROUND ART

For tools that serve to rotate work pieces (in particular screws and nuts), it is frequently necessary to briefly apply an increased torque (for example, initial breakaway torque).

There are various approaches to increase the torque: for hand tools, a handle may be formed appropriately long, in order to generate a high torque across the length in combination with manual force. The disadvantage of these types of tools is their size or their limited convenience for use.

A short-term or impact-type of increased torque may be generated with a compressed air or electric impacting tool or driver. The disadvantage is the connection of these types of tools to a device to generate compressed air or to the electric network.

### SUMMARY OF THE INVENTION

The tool according to the invention serves to rotate a work piece or a device around a rotational axis and has a handle and a shaped component, which can be brought into a form-fitting position with the work piece or the device. Herein the handle is able to swivel around a pivot axis arranged on the section of the handle toward the axis end side, whereby the moment of inertia and/or the momentum of the swiveled handle is transmittable as rotational momentum onto the shaped component and thus onto the work piece or the device, through a limitation on the swivelable extent. Thus an increased torque (for example, an initial breakaway or tightening torque) may be briefly applied onto the work piece or the device.

One embodiment of the invention is a, comprising at least one handle and a shaped component that can be brought into form-fitting position with a work piece, wherein the at least one handle is able to swivel around a pivot axis extending through the shaped component such that rotational momentum is transmittable to the shaped component and the work piece through the moment of inertia and/or the applied momentum of the at least one swiveled handle, wherein the pivot axis coincides with a rotational axis of the work piece.

In a particular aspect of the invention, the moment of inertia and/or the applied momentum is transmittable at the end of a swiveling movement of the at least one handle by at least one contact surface on the handle onto the at least one contact surface on the shaped component side. The at least one handle comprises an end section positioned distally relative to the shaped component. In another aspect of the invention, shaped component is a screw wrench, which can comprises a ratchet with selectable direction and/or a settable torque limiter. In another aspect, the screw wrench is a wrench ring, which can be secured by a ring or U-formed cover, and the ring or cover is swivelable. In another aspect of the invention, the at least one contact surfaces are arranged in a common plane with the pivot axis.

The wrench ring can comprise one or more contact surfaces on the shaped component side per rotational direction, and is enclosed by an intermediate ring fastened to the handle, which comprises two or three contact surfaces on the handle side per rotational direction.

In another aspect of the invention, the handle and the intermediate ring form a single piece and in some embodiments, the length of the handle is changeable. In some embodiments, the handle comprises at least two sections lodged in one another and affixable at different locations. The handle can also further comprise a chamber, into which granulate or a weight guided by the walls of the chamber is placed.

In one embodiment of the invention, the tool further comprising a reduction transmission is arranged between the handle and the shaped component. The tool can further comprise at least one replaceable weight fastened on the handle, wherein that the weights are screwed or inserted onto the handle.

In another embodiment of the invention, the shaped component is a rectangle.

### BRIEF DESCRIPTION OF THE DRAWINGS

FIG. 1 shows a perspective view of a first exemplary embodiment of a tool according to one embodiment of the invention.

FIG. 2 shows a top view of the tool according to FIG. 1.

FIG. 3 shows a top view of a second exemplary embodiment of a tool according to one embodiment the invention.

### DETAILED DESCRIPTION OF THE INVENTION

The presently described invention relates to a tool that is convenient and independent from external energy supplies, and with which one can generate a short-term torque beyond the product of the handle length and manual force.

The tool according to one embodiment of the invention, the tool serves to manually rotate a work piece or a device around a rotational axis, and has a handle and a shaped component, which can be brought into form-fitting position with the work piece or the device. For this, the handle is able to swivel around a pivot axis positioned on an end section of the handle towards the axis, by means of which the moment of inertia and/or the momentum of the swiveled handle is transmittable as rotational momentum onto the shaped component and thus onto the work piece or the device. Thus an increased torque (for example, an initial breakaway or tightening torque) can be applied briefly onto the work piece or the device, whereby the tool is convenient and independent from external energy supplies.

It is preferable that the moment of inertia or the momentum is transmittable at the end of a swiveling movement of the handle by at least one contact surface on the handle side onto at least one contact surface on the shaped component side.

In a preferred further development of the tool, a majority of the mass of the handle is arranged on an end section of the handle positioned opposite to the end section of the handle on the swiveling axis side. By this means the torque-momentum is increased, for unchanged swiveling velocity and for unchanged total mass of the tool.

In a preferred further development the tool is an impacting screw wrench and the work piece is a screw or nut.

In a preferred further development of the impacting screw wrench, it comprises a ratchet and/or a settable torque limiter. By means of the ratchet, the impacting screw wrench can be operated in the same angular region in multiple swivel movements one after another, without needing to disengage the form-fitting connection between the impacting screw wrench and the screw in the meantime. By means of the torque limiter a maximum tightening torque may be set when tightening a screw, so as not to overload the screw connection.

Depending on the design, it may be of advantage here when the impacting screw wrench is a ring wrench, and the shaped component is formed as replaceable sockets or wrench rings. By this means the impacting screw wrench can be employed for different forms (hex nut, hex socket, Torx®) and/or screw sizes.

In a particularly preferred further development of the ring wrench, the respective wrench ring in use is secured against falling out by a cover that is fastened so as to be able to swivel or shifted on the intermediate ring or handle. Here the ring wrench may comprise sealing lips, which are arranged between the cover and the intermediate ring, and which protect the placement area and the contact surfaces between the intermediate ring and the wrench ring from dirt.

It is alternatively preferable that the device to be rotated belongs to a tension mechanism of a tensioning means. This could be, for example, a vise, with which objects (for example, work pieces) may be set under tension. Here the briefly increased torque may be used to securely fasten the object.

It is especially preferable that each contact surface is arranged in a common plane with the pivot axis. By this means a maximal momentum can be transmitted, for minimal size of the contact surface(s) or minimal area pressure.

In an especially preferred exemplary embodiment of the tool according to the invention, the pivot axis coincides with the work piece axis. By this means the rotational momentum transferred onto the work piece axis is maximized, for unchanged swiveling velocity and mass of the handle.

For reasons of a secure momentum transfer, it is preferable that the wrench ring comprises two or three contact surfaces per rotational direction on the shaped component side, and is enclosed by an intermediate ring fastened so as to be rotatable to the handle, which comprises two or three contact surfaces per rotational direction on the handle side.

The handle and the intermediate ring are preferably manufactured as a single piece.

In a preferred further development of the tool, the length of the handle is changeable. By this means, the leverage arm of portions of the handle's mass, and thus the strength of the rotational momentum can be changed.

Here it is preferable that the handle comprises at least two sections, which are lodged in one another, and may be affixed to one another at different positions. By this means a handle is created with a handle length that is easy to change.

In a preferred further development a reduction transmission is arranged between the handle and the shaped component. By this means the strength of the rotational momentum can be changed.

In a preferred further development at least one replaceable weight is fastened to the handle. By this means the strength of the rotational momentum can be easily changed.

Here it is preferable that the weight(s) may be screwed onto the handle. By this means the weights can be easily adjusted.

In a preferred further development the shaped component is rectangular, into which different sockets may be inserted. Here the shaped component is replaceable, so that rectangular insertion options for sockets with different gauges also exist. By this means conventional sockets of differing wrench sizes and various gauges (for example, ½ inch square) may be used with the tool according to the invention.

In a preferred further development the handle comprises a chamber, into which granulate or a weight guided by the walls of the chamber is placed. By this means a rebound is absorbed or compensated, through which the hand and arm of the user is relieved.

The following describes different exemplary embodiment of the invention in detail with regard to the figures, showing:

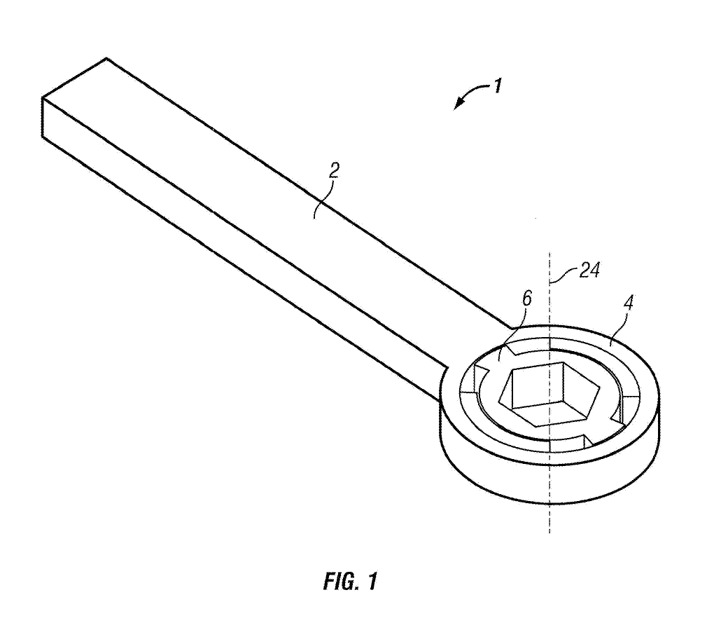

FIG. 1 shows an initial exemplary embodiment of an impacting screw wrench 1 according to the invention in a perspective view. The impacting screw wrench 1 comprises fundamentally a handle 2, an intermediate ring 4, and a socket or a wrench ring 6. The handle 2 is manufactured from massive metal and possesses the form of a long rectangular block, wherein the edges are rounded off. The handle 2 is securely affixed to the intermediate ring 4 (for example, welded or manufactured as a single piece), wherein an external cladding surface of the intermediate ring 4 has a circular cylindrical form and approximately the same height as the handle 2.

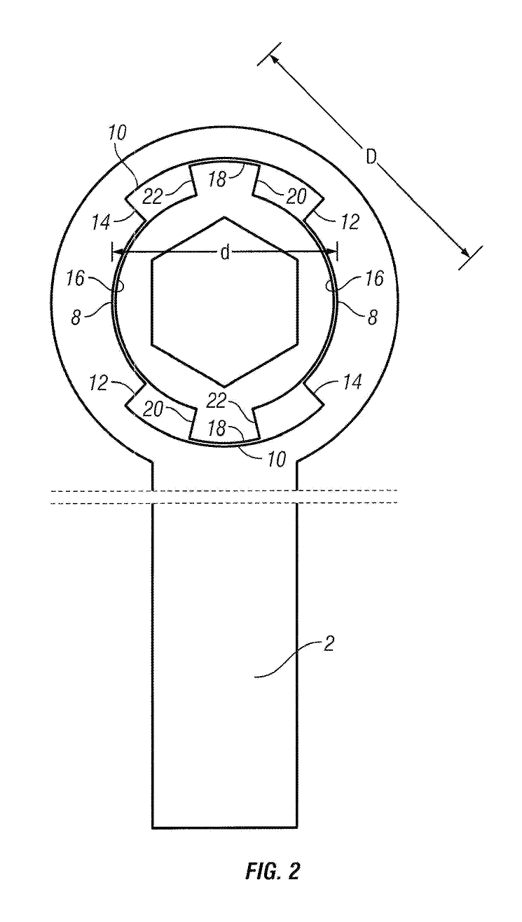

FIG. 2 shows a top view of the intermediate ring 4 with the handle 2 and the wrench ring 6 of the impacting screw wrench 1 according to the first exemplary embodiment, wherein the handle 2 is shown shortened.

An inner circumferential area of the intermediate ring 4 is divided into four approximately equally sized inner circumferential sections 8, 10, so that each inner circumferential section 8, 10 extends over approximately 90° of the inner circumference. Here two oppositely positioned inner circumferential sections 8 of the intermediate ring 4 have a diameter d, whereas two (likewise positioned oppositely) inner circumferential sections 10 have a diameter D, which is greater than the diameter d.

At each of the four locations with a change in diameter distributed across the inner circumference of the intermediate ring 4, an approximately rectangular contact surface 12, 14 develops, whose width is approximately half the difference in diameter between D and d, and whose length corresponds to the height of the intermediate ring 4.

The wrench ring 6 is inserted in the intermediate ring 4 with some amount of play so as to be rotatable, and secured axially against falling out. The outer circumference of the wrench ring 6 is divided into two oppositely positioned inner circumferential sections 16 and two likewise oppositely positioned outer circumferential sections 18. Both inner circumferential sections 16 each extend over approximately 150° on the outer circumference of the wrench ring 4 and comprise here diameter d, while both outer circumferential sections 18 each extend over approximately 30° and here comprise a diameter D.

At the four locations of the outer circumference of the wrench ring 6 with a change in diameter, four rectangular areas 20, 22 result, whose width in the radial direction is half of the difference in diameter between D and d, while the length of the areas 20, 22 corresponds approximately to the height of the wrench ring 6 or of the intermediate ring 4.

The short sides of both opening surfaces 12 on the intermediate ring side, of both closing surfaces 14 on the intermediate ring side, of both opening surfaces 20 on the wrench ring side, and of both closing surfaces 22 on the wrench ring side each extend in radial direction toward the rotational axis 24 (compare FIG. 1) of the screw or nut or another component (not shown) to be rotated.

The following describes the function of the first exemplary embodiment of the tool according to the invention according to FIGS. 1 and 2.

In FIGS. 1 and 2 the impacting ring wrench 1 according to the invention is shown in an intermediate position.

The socket or the wrench ring 6 encloses a screw or nut (not shown) to be rotated.

The middle axis of the screw or nut that runs perpendicular to the plane of the drawing in FIG. 2 coincides with the rotational axis 24 of the concentrically arranged intermediate ring 4 or the pivot axis 24 of the handle 2.

If, for example, the handle 2 is swiveled manually counter-clockwise around the rotational/swivel axis 24, after a rotation of approximately 30° both opening surfaces 12 on the intermediate ring side strike the opening surfaces 20 on the wrench ring side; or with a rotation of approximately 30° in clockwise direction the closing surfaces 14 on the intermediate ring side strike both closing surfaces 22 on the wrench ring side. If this occurs with a swivel or rotational velocity greater than 0, the moment of inertia or the momentum of the swiveled handle 2 is transmitted via the firmly connected intermediate ring 4 via the described contact surfaces 12, 14 on the intermediate ring side to the corresponding contact surfaces 20, 22 on the wrench ring side in such a manner, that the wrench ring 6 is impacted by a rotational momentum. The strength of this rotational momentum depends on the mass of the handle 2, the distance of the portions of the mass from the rotational or pivot axis 24, and on the swiveling velocity of the handle 2. This rotational momentum according to the invention can support or supersede a manual force, and thus serves the user as a torque amplifier.

Using a holding mechanism (not shown) that is arranged on the intermediate ring 4 or on the handle 2, the socket or the wrench ring 6 can be held in the intermediate ring 4, whereby an exchange of the wrench ring 6 can occur by means of intermediately disengaging the holding mechanism. Replacement sockets or wrench rings (not shown) comprise the form shown in FIG. 2 on their outer circumference, whereas the respective hex sockets have differing sizes or other shapes.

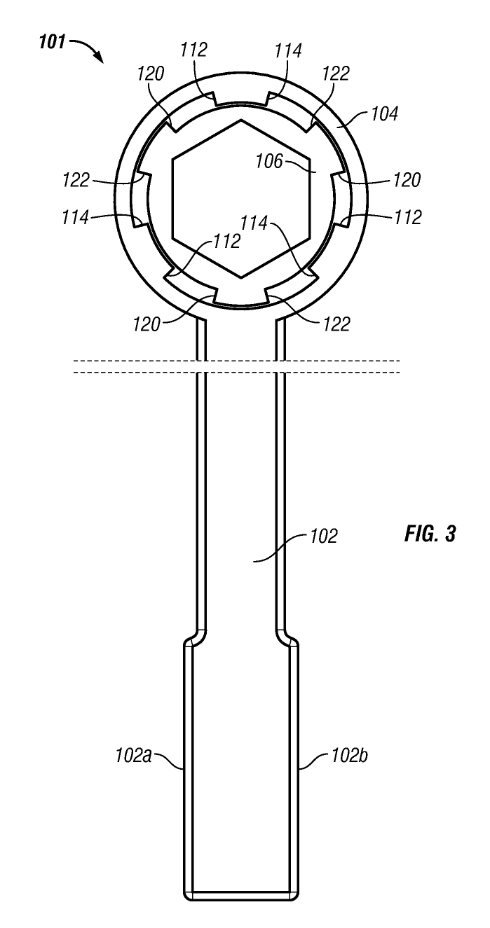

FIG. 3 shows a second exemplary embodiment of an impacting screw wrench 101 according to the invention in a top view, wherein the impacting screw wrench 101 comprises the same principle corresponding to the invention as the impacting screw wrench 1 according to FIGS. 1 and 2.

A significant difference in this exemplary embodiment is the number of contact surfaces. The intermediate ring 104 has on the inner circumference a distribution of three opening surfaces 112 towards the intermediate ring arranged with a separation of 120° respectively, and offset from that three closing surfaces 114 towards the intermediate ring arranged with a separation of 120° respectively.

The wrench ring 106 has distributed on its outer circumference three opening surfaces 120 on the wrench ring side arranged with a separation of 120° respectively and offset from that three closing surfaces 122 arranged on the wrench ring side likewise separated by 120° respectively.

By means of this modification, the rotational impulses are transmitted by three contact surface pairs in each rotational direction, whereby these contact surfaces may be designed smaller for the same maximum area pressure. By this means, the design of the outer circumference of the intermediate ring 104 may be smaller and/or the hex socket of the wrench ring 106 may be larger, for example.

The two side flanks 102a, 102b of the handle 102 comprise a smaller separation on the section of the handle 102 towards the intermediate ring end than on the free end section. By means of such a concentration of the handle's mass in the greatest possible distance from the rotational or pivot axis, the rotational momentum that can be generated is increased supra-proportionally.

In variation from the diagrammed exemplary embodiments of the present invention, the tool may also have only one pair or more than three pairs of contact surfaces on the sides towards the handle and towards the shaped component.

In addition, the free swivel angle of the handle may differ from the angular values shown. In particular, the swivel angle can be larger when the number of pairs of contact surfaces is decreased, or vice-versa.

The contact surfaces also do not have to lie in one plane with the swiveling or rotational axis respectively for the exemplary embodiments with a common rotational/swivel axis (FIGS. 1 and 2). The contact surfaces may also be tilted in such a manner, that their planes lie parallel to the axis. Then, in addition to the component of force necessary for the rotational momentum, a force component directed radially inward or outward develops between the wrench ring and the intermediate ring in the collision of the contact surfaces.

The handle may also variantly comprise, for example, the shape of an I-beam. Or, the handle may be manufactured from a different material as metal (for example, from plastic). Both variations are then especially advantageous, when the moment of inertia required is fundamentally generated by means of the weights fastened to the swivelled end of the handle.

The tool may also variantly comprise two handles, in particular when the pivot axis and the rotational axis coincide.

In variance from the exemplary embodiments of the present invention shown, the wrench ring (6; 106) may be manufactured so that the wrench ring (6; 106) can be brought into position with another object (for example, an extension), and the wrench ring (6; 106) can be held parallel to and centered on the rotational axis (24) of the work piece during the swiveling movement.

The object may also be a handle that is removable, or is manufactured as one piece with the wrench ring (6; 106).

The end of the handle opposite from the wrench ring (6; 106) may be manufactured so that an object (for example, an extension) can be attached, in order to extend the leverage arm of the tool.

The unscrewable weight may for example be manufactured so that an object (for example, an extension) can be attached, in order to extend the leverage arm of the tool.

The tool according to the invention serves to rotate a work piece or a device around a rotational axis and has a handle and a shaped component, which can be brought into form-fitting position with the work piece or the device. Herein the handle is able to swivel around a pivot axis arranged on the section of the handle toward the axis end side, whereby the moment of inertia and/or the momentum of the swiveled handle is transmittable as rotational momentum onto the shaped component and thus onto the work piece or the device. Thus an increased torque (for example, an initial breakaway torque or tightening torque) may be briefly applied onto the work piece or the device.

### LIST OF REFERENCE NUMERALS

1; 101; impacting screw wrench
2; 102; handle
102a, 102b side flank
4; 104 intermediate ring
6; 106; wrench ring
8 inner circumferential section
10 outer circumferential section
12; 112 opening surface on the intermediate ring side
14; 114 closing surface on the intermediate ring side
16 inner circumferential section
18 outer circumferential section
20; 120; opening surface on the wrench ring side
22; 122; closing surface on the wrench ring side
24 rotational and swivel axis

1. A tool, comprising:
at least one handle and a shaped component that can be brought into form-fitting position with a work piece, wherein the at least one handle is able to swivel around a pivot axis extending through the shaped component such that rotational momentum is transmittable to the shaped component and the work piece through the moment of inertia and/or the applied momentum of the at least one swiveled handle, wherein the pivot axis coincides with a rotational axis of the work piece.

2. The tool of claim 1, wherein the moment of inertia and/or the applied momentum is transmittable at the end of a swiveling movement of the at least one handle by at least one contact surface on the handle onto the at least one contact surface on the shaped component side.

3. The tool of claim 1, wherein the at least one handle comprises an end section positioned distally relative to the shaped component.

4. The tool of claim 1, wherein shaped component is a screw wrench.

5. The tool of claim 4, wherein the screw wrench comprises a ratchet with selectable direction and/or a settable torque limiter.

6. The tool of claim 4, wherein the screw wrench is a wrench ring.

7. The tool of claim 6, wherein the ring wrench ring is secured by a ring or U-formed cover.

8. The tool of claim 7, wherein the ring or cover is swivelable.

9. The tool of claim 2, wherein the at least one contact surfaces are arranged in a common plane with the pivot axis.

10. The tool of claim 6, wherein the wrench ring comprises one or more contact surfaces on the shaped component side per rotational direction, and is enclosed by an intermediate ring fastened to the handle, which comprises two or three contact surfaces on the handle side per rotational direction.

11. The tool of claim 10, wherein the handle and the intermediate ring form a single piece.

12. The tool of claim 1, wherein the length of the handle is changeable.

13. The tool of claim 12, wherein the handle comprises at least two sections lodged in one another and affixable at different locations.

14. The tool of claim 1, further comprising a reduction transmission is arranged between the handle and the shaped component.

15. The tool of claim 1, further comprising at least one replaceable weight fastened on the handle.

16. The tool of claim 15, wherein that the weights are screwed or inserted onto the handle.

17. The tool of claim 1, wherein the shaped component is a rectangle.

18. The tool of claim 1, wherein the handle further comprises a chamber, into which granulate or a weight guided by the walls of the chamber is placed.
